(19) United States
(12) Patent Application Publication
(10) Pub. No.: US 2026/0024834 A1
(43) Pub. Date: Jan. 22, 2026

(54) ACCESSORY AND COOLING SYSTEM

(71) Applicant: CANON KABUSHIKI KAISHA, Tokyo (JP)

(72) Inventor: YUTO KASUMI, Tokyo (JP)

(21) Appl. No.: 19/265,974

(22) Filed: Jul. 10, 2025

(30) Foreign Application Priority Data
Jul. 16, 2024 (JP) 2024-113076

(51) Int. Cl. H01M 10/623; G03B 17/56; H01M 10/613; H01M 10/6563; H01M 50/247; H01M 50/262

(52) U.S. Cl. CPC H01M 10/623; H01M 10/613; H01M 10/6563; H01M 50/247; H01M 50/262; G03B 17/56; H01M 2220/30

(57) ABSTRACT

An accessory attachable to an image capturing apparatus includes a cooling fan, an intake port that draws air into the cooling fan, a blow port that blows out air discharged from the cooling fan, a first battery chamber, a second battery chamber, where the cooling fan is located between a first battery chamber and a second battery chamber, and where the blow port is on a surface that connects the accessory to the lower surface of the image capturing apparatus.

### BACKGROUND

### Field of the Technology

The present disclosure relates to an accessory that cools an image capturing apparatus, and a cooling system.

### Description of the Related Art

Conventionally, external power supply devices (hereinbelow, referred to as battery grips) are known that are attachable to image capturing apparatuses and enable the image capturing apparatuses to extend use time and to perform vertical position operation (operation in a case where a user captures a vertically long image). Japanese Patent Application Laid-Open No. 2022-24829 discusses a battery grip that adopts a configuration (hereinbelow, referred to as a magazine configuration) in which an internal space for storing a plurality of batteries and an operation member for a vertical position operation are provided and the plurality of batteries is stored in a single housing and replaced by inserting and removing the housing into and from the internal space. The plurality of batteries supplies power to an image capturing apparatus, so that use time of the image capturing apparatus can be extended.

### SUMMARY

According to an aspect of the present disclosure, an accessory attachable to an image capturing apparatus includes a fan, an intake port configured to draw air into the fan, a blow port configured to blow out air discharged from the fan, a first battery chamber, and a second battery chamber, wherein the first battery chamber and the second battery chamber are located on a surface perpendicular to an attachment/detachment direction of the accessory, wherein the fan is located between the first battery chamber and the second battery chamber, and wherein the blow port is located on a surface including an attachment unit enabling the accessory to be attached to a lower surface of the image capturing apparatus.

Features of the present disclosure will become apparent from the following description of embodiments with reference to the attached drawings. The following description of embodiments are described by way of example.

### BRIEF DESCRIPTION OF THE DRAWINGS

FIGS. 1A and 1B are external perspective views of a camera system.

FIGS. 2A and 2B are bottom perspective views of a camera main body.

FIG. 3 is an exploded perspective view of the camera main body.

FIG. 4 is an exploded perspective view of a rear surface cover unit and a side surface cover unit of the camera main body.

FIG. 5 is a top perspective view of a heat dissipation module.

FIG. 6 is a rear perspective view of the heat dissipation module.

FIG. 7 is an exploded perspective view of the heat dissipation module.

FIG. 8 is a cross-sectional view of the camera system.

FIG. 9 is a top view of a main body unit.

FIG. 10 is an external perspective view of a battery.

FIG. 11 is a rear perspective view in a state where the battery is inserted into the heat dissipation module.

### DESCRIPTION OF THE EMBODIMENTS

In recent years, data rates of videos handled by image capturing apparatuses have become enormous due to higher resolutions of videos such as 4K and 8K pixels, higher frame rates such as 120 frames per second and 240 frames per second, and support for a high dynamic range. Accordingly, power consumption required for calculation and recording of the data increases, and shortening of available imaging time due to heat generation in the image capturing apparatuses has become an issue. As a measure for cooling an image capturing apparatus, it is conceivable to provide a cooling unit such as a fan to the battery grip discussed in Japanese Patent Application Laid-Open No. 2022-24829 to cool the image capturing apparatus, but there are various issues in this case.

The present disclosure is directed to an accessory that can suitably achieve both a configuration that can supply power to an image capturing apparatus and a configuration that can cool the image capturing apparatus.

Exemplary embodiments of the present disclosure will be described in detail below with reference to the attached drawings.

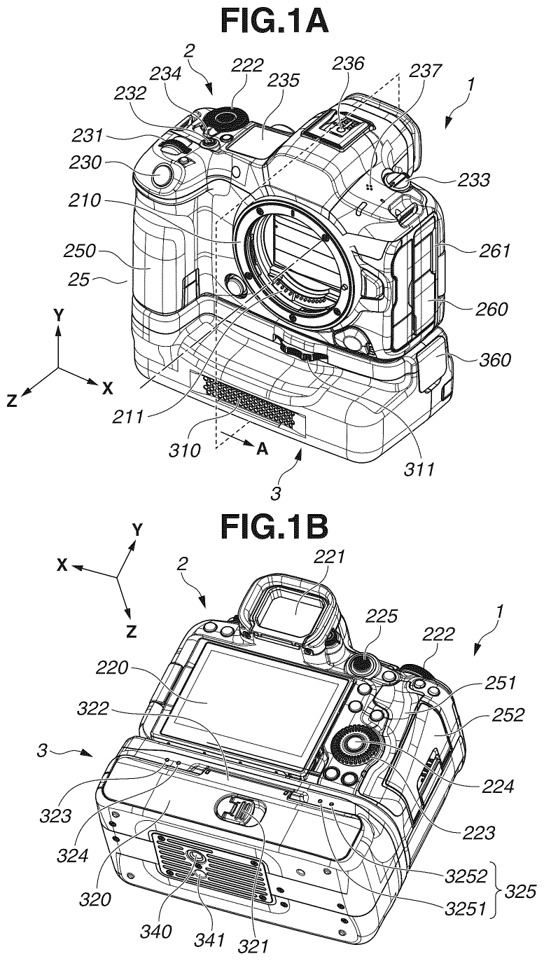

A configuration of a camera system 1 according to the present exemplary embodiment is described below with reference to FIGS. 1A and 1B. FIGS. 1A and 1B are external perspective views of the camera system 1 according to the present exemplary embodiment. FIG. 1A is a front perspective view of the camera system 1 and FIG. 1B is a rear perspective view of the camera system 1.

The camera system 1 according to the present exemplary embodiment is includes a camera main body 2, a heat dissipation module 3, and an interchangeable lens barrel (not illustrated). The camera main body 2 is an example of an image capturing apparatus. The camera main body 2 according to the present exemplary embodiment is exemplified as a mirror-less type digital camera to which the interchangeable lens barrel can be attached, but it may also be a digital video camera or a camera in which the camera main body 2 and the lens barrel are integrated.

The heat dissipation module 3 is an accessory that can be attached to the camera main body 2 to dissipate heat therefrom. External air drawn in by the heat dissipation module 3 in a state where the heat dissipation module 3 is attached to the camera main body 2 is discharged to an intake port of the camera main body 2. Even if the camera main body 2 does not include a cooling fan for drawing in external air, it can still draw in external air. When the air discharged from the heat dissipation module 3 and drawn in from the intake port of the camera main body 2 passes through a camera duct provided inside the camera, the air draws heat from a heat generation unit thermally connected to the camera duct. The air drawing the heat is discharged from an exhaust port of the camera main body 2, so that the heat is dissipated from the camera main body 2. This enables a cooling system for cooling the camera main body 2 to be realized by combining the camera main body 2 with the heat dissipation module 3.

### <Configuration of Camera Main Body>

A configuration of the camera main body 2 is described below with reference to FIGS. 1A and 1B. Unless otherwise noted below, in the camera main body 2, a subject side in an optical axis direction is referred to as a front surface side, a surface facing the front surface is referred to as a rear surface side, and left and right sides if viewing the camera main body 2 from the rear surface side are respectively referred to as a left surface side and a right surface side. An upper side is referred to as an upper surface side and a lower side is referred to as a lower surface side (the lower surface and the lower surface side are also referred to as a bottom surface and a bottom surface side, respectively). While many operation members and the like are illustrated in the drawings, the descriptions of some of the operation members are omitted.

In FIG. 1A, the camera main body 2 includes, at the center of the front surface side, a mount 210 to which the interchangeable lens barrel (not illustrated) can be detachably attached. The mount 210 includes a communication terminal 211 through which the camera main body 2 communicates with the lens barrel.

The camera main body 2 is provided on the upper surface side with a shutter button 230, a main electronic dial 231, a moving image button 232, a still image/moving image changeover switch 233, a power supply switch 234, an upper surface side display unit 235, an accessory shoe 236, and an audio input unit 237.

The shutter button 230 is a button for issuing an imaging instruction. The main electronic dial 231 is a button for changing various setting values and the like. The moving image button 232 is a button for issuing an instruction to start and stop capturing (recording) a moving image. The still image/moving image changeover switch 233 is a button for switching between a still image capturing mode and a moving image capturing mode. The power supply switch 234 is a button for switching the power supply of the camera main body 2 ON and OFF. The upper surface side display unit 235 is a button for displaying various setting values of the camera main body 2.

The accessory shoe 236 is a member for enabling attachment and detachment of an external device, such as a video microphone, to and from the camera main body 2. The audio input unit 237 acquires audio input to the camera main body 2 during imaging.

The left surface side of the camera main body 2 includes a connector (not illustrated) for connecting the camera main body 2 to an external device such as a video microphone, a connector cover 260 for protecting the connector, and an exhaust port 261. The exhaust port 261 is an outlet for externally discharging the air in the camera duct located inside the rear surface side of the camera main body 2 from the camera main body 2.

The camera main body 2 includes a grip unit 25 enabling a user to grip the camera main body 2 on the right surface side. The grip unit 25 is shaped so that the user can easily grip it with the user's right hand from the front surface side to the rear surface side, and includes a front surface rubber 250 on the front surface side and a rear surface rubber 251 on the rear surface side to prevent the user's hand from slipping.

In FIG. 1B, the camera main body 2 includes a rear surface display unit 220 that displays a captured image and various types of information at the center of the rear surface side.

The camera main body 2 includes an eyepiece finder 221 including an electronic viewfinder on the upper surface side of the camera main body 2.

The right surface side of the camera main body 2 includes various operation members such as a sub electronic dial 222 and a rear surface electronic dial 223 that are used to change various setting values as in the main electronic dial 231, a SET button 224 for determining a selected item, and a multi-controller 225. The multi-controller 225 can be operated by pressing a key top as well as tilting the key top to indicate a direction, and is mainly used for moving a selection frame and moving and selecting in various setting menus.

The right surface side of the camera main body 2 includes a card slot cover 252 that protects a card slot for storing a recording card, and is located on a gripping portion of the grip unit 25.

### <Configuration of Heat Dissipation Module>

A configuration of the heat dissipation module 3 according to the present exemplary embodiment is described below with reference to FIGS. 1A and 1B.

In FIG. 1A, the heat dissipation module 3 includes an intake port 310 at the center of the front surface side. The intake port 310 is an inlet for drawing external air into a cooling fan located inside the heat dissipation module 3.

The heat dissipation module 3 includes a dial 311 at the center of the upper surface side, which is an operation member for rotating a male screw member (not illustrated) that couples the camera main body 2 and the heat dissipation module 3.

The heat dissipation module 3 includes a connector cover 360 on the left surface side that protects a connector for connecting the camera main body 2 to an external device via the heat dissipation module 3.

In FIG. 1B, the heat dissipation module 3 includes a battery lid 320 spanning the left and right sides on the rear surface side. The battery lid 320 includes a battery lid knob 321 at the center and a battery lid shaft portion 322 at the central upper surface side. The battery lid 320 is opened and closed by lifting and rotating the battery lid knob 321, and can be opened by an urging force of a spring around the battery lid shaft portion 322 as a rotation shaft.

The battery lid shaft portion 322 includes a connector lamp 323 and a cooling fan lamp 324 on the left surface side and a power supply lamp 325 on the right surface side. The connector lamp 323 is turned on based on a connection state with an external device connected via a connector 339. The cooling fan lamp 324 is turned on if a cooling fan 70 rotates and is turned off if the cooling fan 70 does not rotate, which enables the user to recognize a rotation state of the cooling fan 70. The power supply lamp 325 includes a first power supply lamp 3251 and a second power supply lamp 3252, which are respectively turned on based on charging states of batteries stored in a first battery chamber included on the left surface side and in a second battery chamber located on the right surface side of the heat dissipation module 3.

The lower surface side of the heat dissipation module 3 includes a female screw member 340 for fixing the camera system 1 to a tripod or the like, and a video boss hole 341 for engaging with a video camera tripod's video boss to prevent rotational deviation of the camera system 1.

### <Configuration of Lower Surface Side of Camera Main Body>

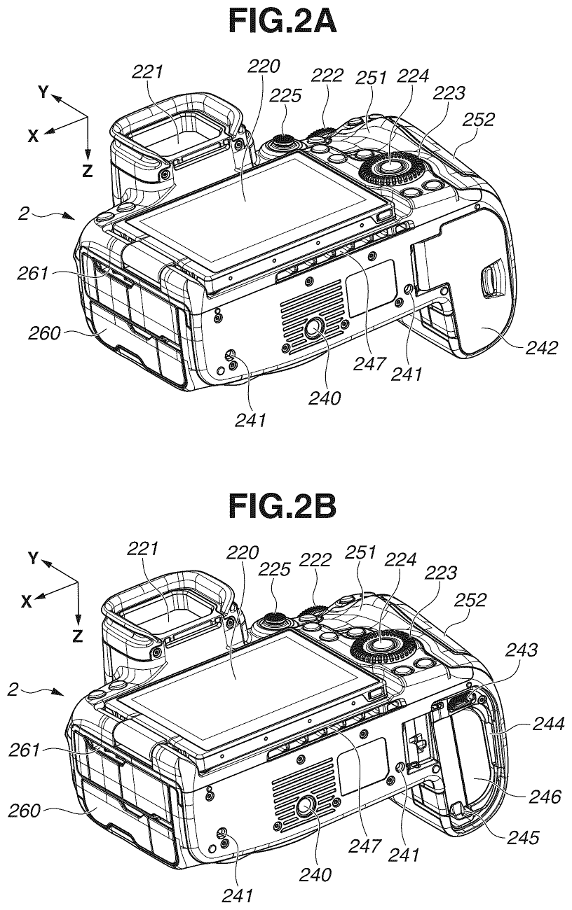

A configuration of the lower surface side of the camera main body 2 according to the present exemplary embodiment is described below with reference to FIGS. 2A and 2B. FIGS. 2A and 2B are bottom perspective views of the camera main body 2 according to the present exemplary embodiment. FIG. 2A is the bottom perspective view of the camera main body 2 in a state where a camera battery lid 242 is attached thereto. FIG. 2B is the bottom perspective view of the camera main body 2 in a state where the camera battery lid 242 is removed therefrom.

In FIGS. 2A and 2B, the lower surface side of the camera main body 2 includes a camera female screw member 240, a positioning hole 241, the camera battery lid 242, a receptacle connector 243, a camera battery chamber 244, and a camera battery lock lever 245. In a case where the camera main body 2 is used alone, the camera female screw member 240 is used to fix the camera main body 2 to a tripod or the like. According to the present exemplary embodiment, the camera female screw member 240 is used to couple the camera main body 2 and the heat dissipation module 3. The positioning hole 241 is engaged with a positioning pin 331 of the heat dissipation module 3 to adjust a relative position of the camera main body 2 and the heat dissipation module 3. The camera battery lid 242 is attached in a case where the camera main body 2 is used alone, but is removed in a case where the camera main body 2 is used with the heat dissipation module 3 attached.

In FIG. 2B, in a case where the camera battery lid 242 is removed, the receptacle connector 243, the camera battery chamber 244, a battery 246, and the camera battery lock lever 245 are exposed on the lower surface side of the camera main body 2. The receptacle connector 243 is compatible with various accessories, including the heat dissipation module 3, which can be attached to and detached from the camera main body 2, and exchanges electrical signals with the various accessories. The camera battery chamber 244 stores the battery 246, and the camera battery lock lever 245 holds the battery 246 to prevent the battery 246 from falling out of the camera batter chamber 244 even in a state where the camera battery lid 242 is not closed.

### <Internal Configuration of Camera Main Body>

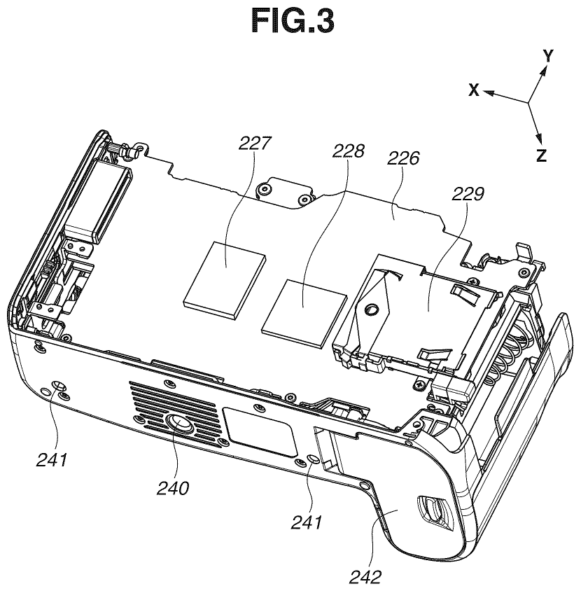

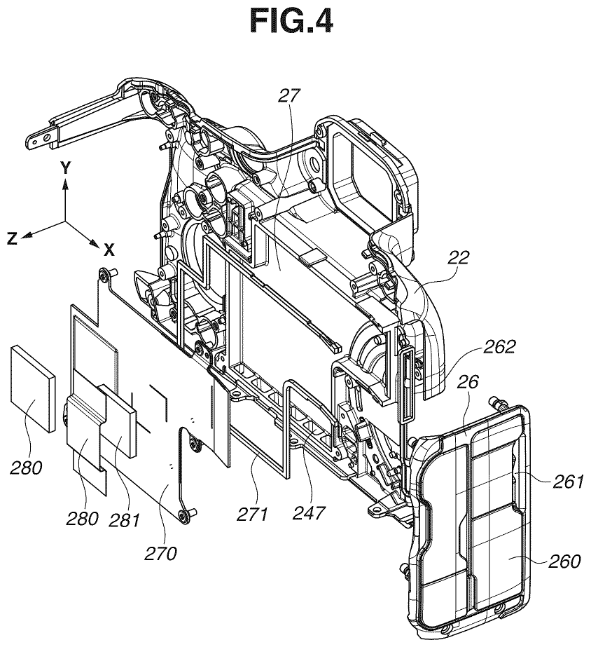

An internal configuration of the camera main body 2 according to the present exemplary embodiment is described below with reference to FIGS. 3 and 4. FIG. 3 is an exploded perspective view of the camera main body 2 in a state where a part of an exterior member is removed. FIG. 4 is an exploded perspective view of a rear surface cover unit and a side surface cover unit of the camera main body 2.

In FIG. 3, the camera main body 2 includes a main substrate 226 inside the rear surface side. Components such as integrated circuits (ICs) 227 and 228 that perform image processing and the like, a card slot 229 that stores a recording card, a power supply circuit component that supplies power to each unit, and various connectors are mounted on the main substrate 226. For simplicity purposes, some of the components, harnesses, and the like mounted on the main substrate 226 are not illustrated. The ICs 227 and 228 are elements that are main heat sources on the main substrate 226 and generate a large amount of heat because capturing high-resolution or high-frame-rate moving image consumes a lot of power for image processing and the like.

In FIG. 4, the camera main body 2 includes a camera duct 27 inside the rear surface side. The camera duct 27 includes a rear surface cover 22 including a ventilation port 247 at the center of the lower surface side, a side surface cover 26 including the exhaust port 261, a heat dissipation sheet metal 270 made of aluminum with good thermal conductivity or the like, and a rear surface sealing member 271 and an exhaust port sealing member 262 made of, for example, high-performance polyurethane foam, a double-sided adhesive tape, or the like. The ventilation port 247 is an inlet for drawing the air sent from the heat dissipation module 3 into the camera duct 27. The exhaust port 261 is an outlet for discharging the air drawn in the camera duct 27 from the ventilation port 247 external to the camera main body 2. The camera duct 27 is formed by coupling the heat dissipation sheet metal 270 to the rear surface cover 22 via the rear surface sealing member 271, and coupling the side surface cover 26 to the rear surface cover 22 via the exhaust port sealing member 262. It is an air passage that communicates from the ventilation port 247 to the exhaust port 261.

A heat transfer member 280, such as a heat-conductive sheet, is attached to the heat dissipation sheet metal 270. According to the present exemplary embodiment, the heat transfer member 280 is attached using a buffer member 281, a double-sided adhesive tape, or the like that contacts the ICs 227 and 228 that are the main heat sources and transfers the heat generated by the ICs 227 and 228 to the heat dissipation sheet metal 270.

In FIGS. 3 and 4, the ICs 227 and 228 are located toward the camera duct 27 on the rear surface side. The heat generated by the ICs 227 and 228 is transferred to the heat dissipation sheet metal 270 via the heat transfer member 280 and dissipated by the air drawn in from the ventilation port 247.

### <Configuration of Upper Surface Side of Heat Dissipation Module>

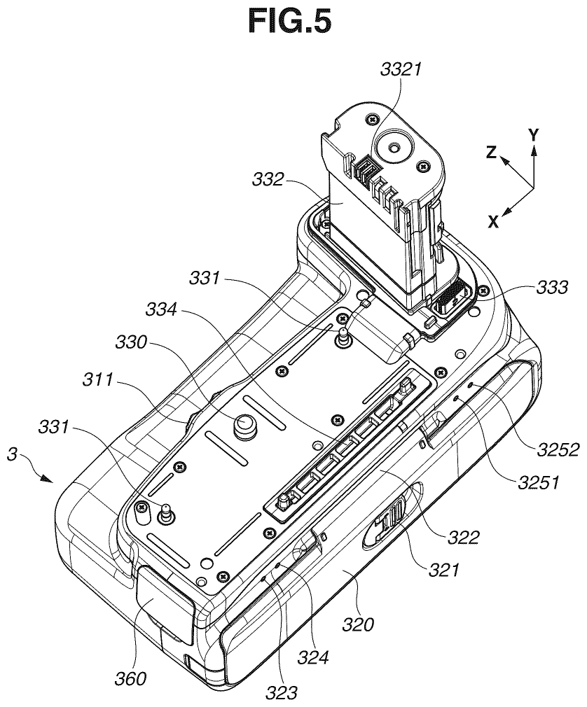

A configuration of the upper surface side of the heat dissipation module 3 according to the present exemplary embodiment is described below with reference to FIG. 5. FIG. 5 is a top perspective view of the heat dissipation module 3.

In FIG. 5, the heat dissipation module 3 is located on the upper surface side and includes a male screw member 330, the positioning pin 331, a tower unit 332, a plug connector 333, and a blow port 334. The male screw member 330 is an attachment unit that rotates in conjunction with an operation of the dial 311 and screws into the camera female screw member 240 to couple the camera main body 2 and the heat dissipation module 3. The positioning pin 331 engages with the positioning hole 241 of the camera main body 2 to adjust the relative position of the camera main body 2 and the heat dissipation module 3. The tower unit 332 includes a tower unit terminal 3321 at its tip end, which is a contact point similar to a battery terminal provided on the battery 246. The tower unit 332 is inserted into the camera battery chamber 244 in a state where the camera battery lid 242 is removed when attaching the heat dissipation module 3 to the camera main body 2. At this time, the tower unit terminal 3321 is connected to a battery contact piece (not illustrated) provided on the camera battery chamber 244 and supplies power from the battery stored in the heat dissipation module 3 to the camera main body 2. The plug connector 333 is connected to the receptacle connector 243 in the state where the camera battery lid 242 is removed when attaching the heat dissipation module 3 to the camera main body 2. At this time, the camera main body 2 and the heat dissipation module 3 are electrically connected and exchange various electrical signals, such as for connecting to an external device via the connector 339 and for acquiring the rotation state of the cooling fan 70. The blow port 334 is an outlet located at the center of the upper surface side of the heat dissipation module 3 and is connected to the ventilation port 247 located at the center of the lower surface side of the camera main body 2 to send the air discharged from the cooling fan 70 to the ventilation port 247.

### <Configuration of Rear Surface Side of Heat Dissipation Module>

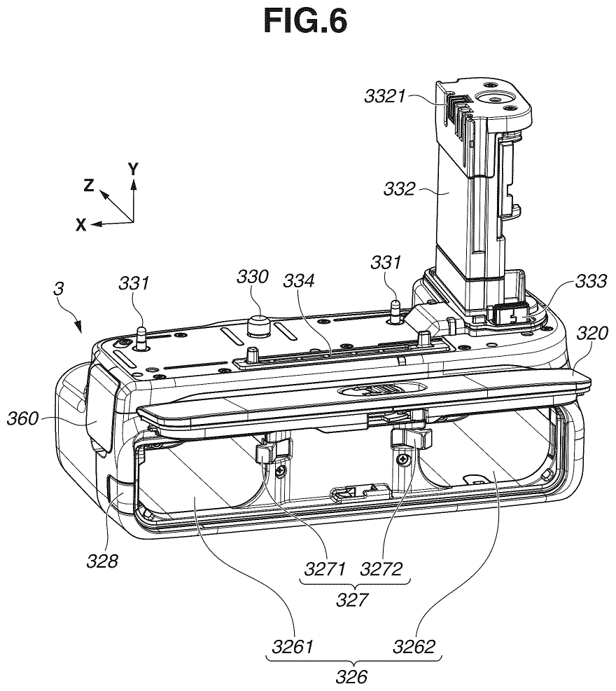

A configuration of the rear surface side of the heat dissipation module 3 according to the present exemplary embodiment is described below with reference to FIG. 6. FIG. 6 is a rear perspective view of the heat dissipation module 3.

In FIG. 6, the heat dissipation module 3 includes a battery chamber 326 and a battery lock lever 327 inside a housing. The battery chamber 326 includes a first battery chamber 3261 and a second battery chamber 3262, each of which can store a battery. The batteries stored in the battery chamber 326 supply power to at least the cooling fan 70 located inside the heat dissipation module 3. The batteries stored in the battery chamber 326 also supply power to the camera main body 2, and can drive the camera main body 2 with the heat dissipation module 3 attached. The two batteries are stored and thus enable long time imaging even under an imaging condition consuming a lot of power. It is desirable that the battery to be stored is the battery 246 used to drive the camera main body 2 considering usability for the user, and according to the present exemplary embodiment, the battery chamber 326 can store the two batteries 246. According to the present exemplary embodiment, the first battery chamber 3261 can store a direct current (DC) coupler (not illustrated) enabling the camera main body 2 to capture images for a long period of time by supplying power directly from a household power supply. A cable for connecting the household power supply and the DC coupler can be drawn out from the first battery chamber 3261 by opening a cable cover 328 even if the battery lid 320 is closed. The first battery chamber 3261 and the second battery chamber 3262 are located on a surface perpendicular to an attachment/detachment direction (up-and-down direction) of the heat dissipation module 3. According to the present exemplary embodiment, they are located at both left and right ends of the housing with a distance between them. The battery lock lever 327 includes a first battery lock lever 3271 and a second battery lock lever 3272 for the first battery chamber 3261 and the second battery chamber 3262 respectively. The battery lock lever 327 is a locking member that holds the battery 246 to prevent the battery 246 from falling out of the batter chamber 326 even in a state where the battery lid 320 is not closed. The first battery lock lever 3271 and the second battery lock lever 3272 are respectively located on the inside of the first battery chamber 3261 and the second battery chamber 3262, which are located at both left and right ends. Accordingly, the battery chamber 326 can be located to extend to both left and right ends of the heat dissipation module 3, and a large space can be provided between the battery chambers 326 in which the cooling fan 70 is arranged.

### <Internal Configuration of Camera System>

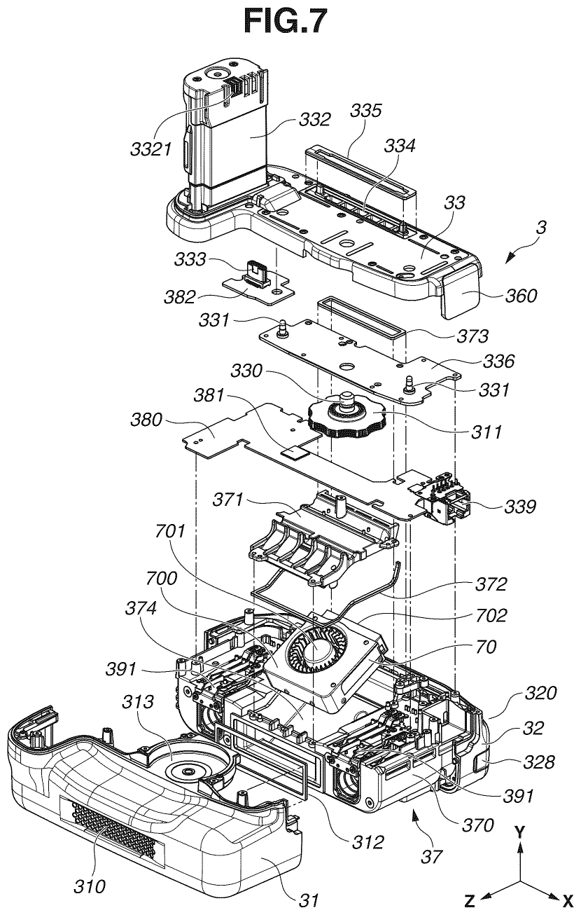

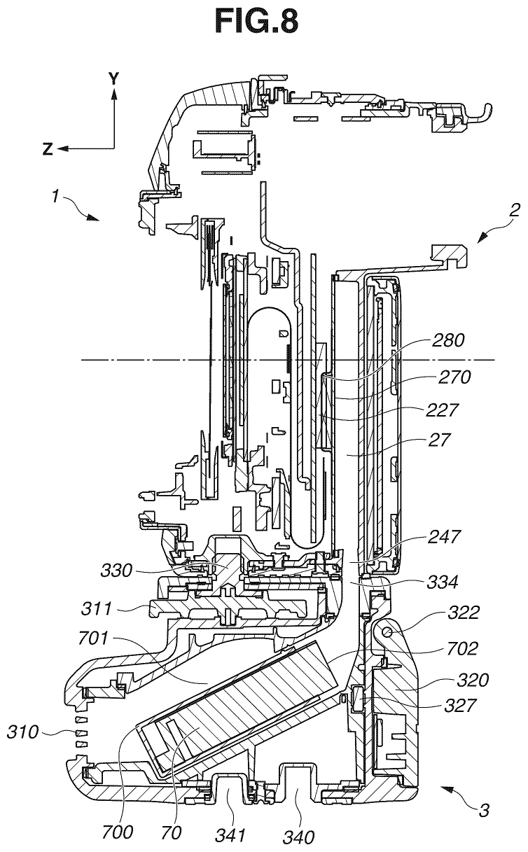

An internal configuration of the camera system 1 including the internal configuration of the heat dissipation module 3 according to the present exemplary embodiment is described below with reference to FIGS. 7 and 8.

FIG. 7 is an exploded perspective view of the heat dissipation module 3, and FIG. 8 is a cross-sectional view of the camera system 1 at the center of an optical axis perpendicular to a right-and-left direction. For simplicity purposes, some of the components, harnesses, fastening members, and the like mounted on the main substrate 226 are not illustrated.

In FIG. 7, the heat dissipation module 3 includes a front surface cover unit 31 on the front surface side, a rear surface cover unit 32 on the rear surface side, an upper surface cover unit 33 on the upper surface side, and a main body unit 37, which is an internal structure. The front surface cover unit 31 includes the intake port 310, an intake port sealing member 312, and a dial seat 313. The rear surface cover unit 32 includes the above-described battery lid 320 and cable cover 328. The upper surface cover unit 33 includes the tower unit 332 including the tower unit terminal 3321, the plug connector 333, a plug connector substrate 382 including the plug connector 333, the blow port 334, a first blow port sealing member 335, and the connector cover 360. The main body unit 37 includes a main body case 370, a main body cover 371, a main body cover sealing member 372, a second blow port sealing member 373, the cooling fan 70, and a cooling fan cover 700. The main body unit 37 includes the dial 311, the male screw member 330, the positioning pin 331, an upper surface plate 336, the connector 339, an accessory substrate 380, and a battery contact piece 391. The main body case 370 includes the above-described battery chambers 326 at both left and right ends and a cooling fan storage unit 374, which has an opening on the upper surface side, at a center portion. The cooling fan storage unit 374 can store the cooling fan 70 to which the cooling fan cover 700 is attached.

The cooling fan 70 is located on the same surface as and between the first battery chamber 3261 and the second battery chamber 3262, which are located at both left and right ends with the distance between them. Accordingly, since the cooling fan 70 is located in the space remaining in a direction (right-and-left direction) perpendicular to the attachment/detachment direction (up-and-down direction) while the two battery chambers are located therein, it is possible to prevent the heat dissipation module 3 from increasing in size in the attachment/detachment direction. The cooling fan 70 is located on the center portion of the heat dissipation module 3, and thus can be aligned in the right-and-left direction with the ventilation port 247 located at the center of the lower surface side of the camera main body 2. Accordingly, an air passage (formed by the duct) from the cooling fan 70 to the blow port 334 can be formed without bending in the right-and-left direction, thereby suppressing a decrease in air volume due to flow path loss. The cooling fan 70 includes a cooling fan intake port 701 and a cooling fan exhaust port 702 and is located obliquely so that the cooling fan exhaust port 702 faces the blow port 334 (FIG. 8). Accordingly, the air passage from the cooling fan 70 to the blow port 334 can be formed with a small bending angle, thereby suppressing a decrease in air volume due to flow path loss. According to the present exemplary embodiment, the cooling fan 70 uses a centrifugal fan that draws in air from the cooling fan intake port 701 located in a direction of a rotation axis of blades and discharges air from the cooling fan exhaust port 702 located in a direction of a rotation diameter of the blades, but the present disclosure is not limited to this. An axial flow fan may also be used that draws in and discharges air in the direction of the rotation axis of the blades. According to the present exemplary embodiment, the cooling fan 70 is located obliquely so that the cooling fan exhaust port 702 faces the blow port 334, but this is not seen to be limiting, and the cooling fan 70 may be located in a horizontal direction (front-to-back direction) or a vertical direction (up-and-down direction).

The cooling fan cover 700 is formed by an elastic member, such as silicone rubber, and is attached to cover the cooling fan 70. The cooling fan cover 700 suppresses a vibration of the cooling fan 70 from being transmitted to a structural member of the heat dissipation module 3.

The accessory substrate 380 is formed to cross over the cooling fan 70 located at the center portion of the heat dissipation module 3. Mounting components, such as a control unit 381 like a central processing unit (CPU) that communicates with the camera main body 2 and controls the cooling fan 70 and a power supply circuit component that supplies power to each unit are mounted on the accessory substrate 380. For simplicity purposes, some of the components, harnesses, and the like on the accessory substrate 380 are not illustrated. The accessory substrate 380 is electrically connected to the tower unit terminal 3321 provided on a tip end of the tower unit 332, the plug connector 333 provided on the plug connector substrate 382, the connector 339 provided on the left surface side of the heat dissipation module 3, and the battery contact piece 391 provided on the upper surface side of the battery chamber 326 via the harness, the connector, and the like.

The control unit 381 is connected to the plug connector 333 via the accessory substrate 380 and the plug connector substrate 382, and is connected to the camera main body 2 via the receptacle connector 243 if the heat dissipation module 3 is attached to the camera main body 2. Accordingly, the camera main body 2 can perform various types of communication with the heat dissipation module 3, such as acquiring the rotation state of the cooling fan 70.

According to the present exemplary embodiment, the control unit 381 is located on the accessory substrate 380 of the heat dissipation module 3, but may be located on the main substrate 226 of the camera main body 2.

The connector 339 is a connector for connecting to an external device, such as a local area network (LAN) connector for file transfer protocol (FTP) transfer and remote imaging via a wired LAN (WLAN) or a Universal Serial Bus (USB) connector for charging and supplying power from an external power supply. In the present exemplary embodiment, a LAN connector is illustrated. The connector 339 mounted on the heat dissipation module 3 in the present exemplary embodiment is a connector that is not mounted on the camera main body 2 or a connector that would increase a size of the camera main body 2 if it is mounted thereon. The connector is mounted on the heat dissipation module 3, so that the camera main body 2 can expand functions without increasing its size. The connector 339 is connected to the plug connector 333 via the accessory substrate 380 and the plug connector substrate 382, and is connected to the camera main body 2 via the receptacle connector 243 if the heat dissipation module 3 is attached to the camera main body 2.

Accordingly, the camera main body 2 can be connected to an external device via the heat dissipation module 3.

The battery contact piece 391 is a contact point component that is connected to the battery 246 inserted into the battery chamber 326 and is located at a position adjacent to the battery chamber 326 and the accessory substrate 380. With this configuration, the battery contact piece 391 and the accessory substrate 380 are integrated, or the harness for connection is shortened, and thus the heat dissipation module 3 can be suppressed from increasing in size. The battery contact piece 391 is connected to the battery 246 inserted into the battery chamber 326. The battery contact piece 391 is connected to the tower unit terminal 3321 via the accessory substrate 380, and is connected to the camera main body 2 via a battery contact piece (not illustrated) located on the camera battery chamber 244 if the heat dissipation module 3 is attached to the camera main body 2. Accordingly, the camera main body 2 can be driven by receiving power supply from the battery 246 inserted into the battery chamber 326.

The front surface cover unit 31 is coupled to the main body case 370 via the intake port sealing member 312. The main body cover 371 is coupled to the main body case 370 via the main body cover sealing member 372. The upper surface cover unit 33 is coupled to the main body case 370 and the main body cover 371 via the second blow port sealing member 373. Accordingly, an air passage is formed that communicates from the intake port 310 to the blow port 334. According to the present exemplary embodiment, the cooling fan 70 is located in the air passage.

The first blow port sealing member 335 is located around the blow port 334 to prevent air leakage or the like between the blow port 334 and the ventilation port 247 of the camera main body 2. Accordingly, if the heat dissipation module 3 is attached to the camera main body 2, an air passage is formed that communicates from the intake port 310 of the heat dissipation module 3 to the exhaust port 261 of the camera main body 2. Each component forming the air passage is coupled without gaps via the sealing members, which enables prevention of air leakage from the internal to the air passage to internal to the camera main body 2 and to internal to the heat dissipation module 3 and leakage of foreign substances such as water and dust.

In FIG. 8, if the cooling fan 70 is rotated, outside air is drawn in from the intake port 310 to the cooling fan intake port 701 of the cooling fan 70. Subsequently, the air drawn in by the cooling fan 70 is discharged from the cooling fan exhaust port 702 by rotation of the blades. The air discharged from the cooling fan 70 travels along an inner wall of the heat dissipation module 3 toward the upper surface side and is discharged from the blow port 334. The air discharged from the blow port 334 is drawn in the camera duct 27 from the ventilation port 247 of the camera main body 2 and is discharged from the exhaust port 261 of the camera main body 2. At this time, the air passing through the camera duct 27 contacts the heat dissipation sheet metal 270, dissipates heat from the heat dissipation sheet metal 270, and dissipates heat from the ICs 227 and 228 via the heat transfer member 280.

The battery lock lever 327 is arranged using a bending portion of the air passage from the cooling fan exhaust port 702 to the blow port 334 to overlap with the air passage near the blow port 334 in the up-and-down direction. Accordingly, there is no need to increase a size of the housing to place the battery lock lever 327.

### <Configuration of Main Body Unit of Heat Dissipation Module>

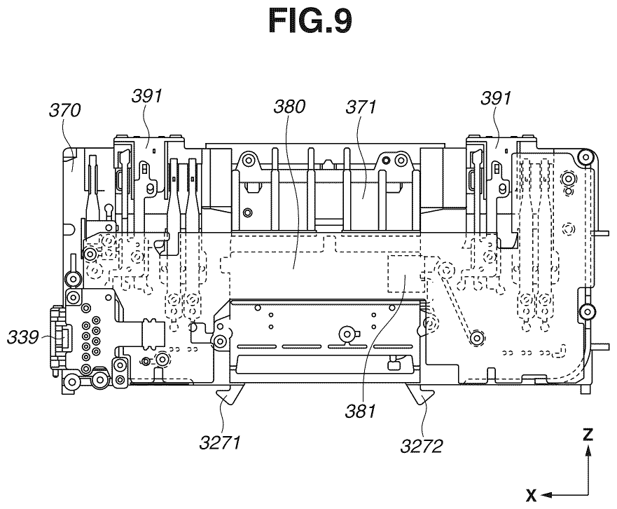

A configuration of the main body unit 37 according to the present exemplary embodiment is described below with reference to FIGS. 7 and 9. FIG. 9 is a top view of the main body unit 37, in which the accessory substrate 380 and the control unit 381 are illustrated in a transparent manner form for the sake of following explanation.

In FIG. 9, the connector 339 is located at a position not overlapping with the battery contact piece 391 if viewed from the upper surface side. The accessory substrate 380 is formed in an area that does not overlap with the connector 339 if viewed from the upper surface side. Accordingly, the battery contact piece 391 and the accessory substrate 380 are located at a position overlapping with the connector 339 with respect to a direction perpendicular to the attachment/detachment direction (up-and-down direction), so that the heat dissipation module 3 can be suppressed from increasing in size in the attachment/detachment direction.

### <Configuration of Heat Dissipation Module Related to Battery>

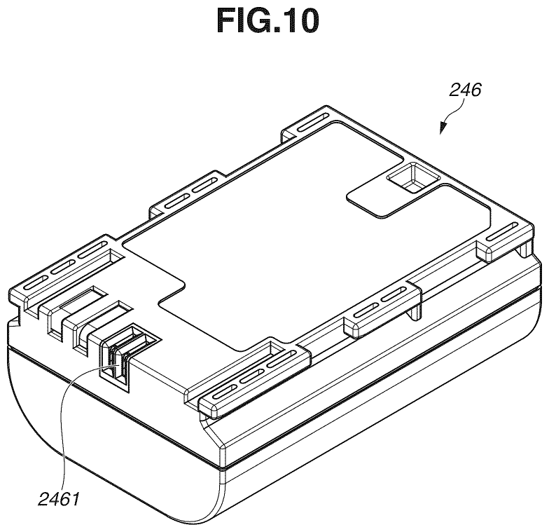

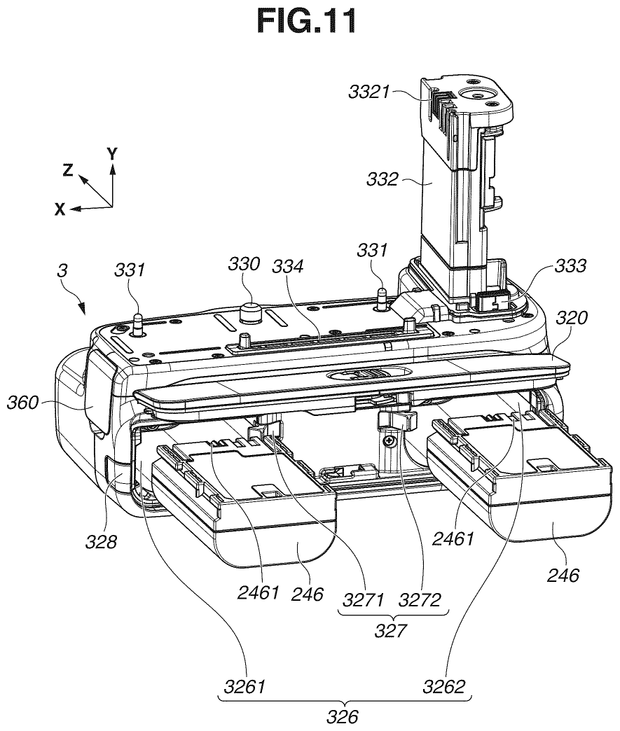

A configuration of the battery 246 and insertion and removal of the battery 246 with respect to the heat dissipation module 3 according to the present exemplary embodiment are described below with reference to FIGS. 10 and 11. FIG. 10 is an external perspective view of the battery 246 and FIG. 11 is a rear perspective view in a state where the battery 246 is inserted into the heat dissipation module 3.

In FIG. 10, the battery 246 includes a battery terminal 2461 for power supply on the side surface. The battery 246 is inserted into the camera battery chamber 244 of the camera main body 2, which connects the battery terminal 2461 to a battery contact piece (not illustrated) located on the camera battery chamber 244, and power is supplied to the camera main body 2. The battery 246 is inserted into the battery chamber 326 of the heat dissipation module 3 in a state where the heat dissipation module 3 is attached to the camera main body 2, resulting in connecting the battery terminal 2461 with the battery contact piece 391 located on the battery chamber 326. At this time, the battery 246 supplies power to the camera main body 2 via the tower unit terminal 3321 of the tower unit 332, while also supplying power to the cooling fan 70 located inside the heat dissipation module 3.

In FIG. 11, the battery 246 is inserted into the battery chamber 326 from the rear surface side toward the front surface side so that its longitudinal direction is parallel to the optical axis direction with the battery lid 320 open. The battery 246 is inserted into the battery chamber 326 so that the battery terminal 2461 faces the upper surface side in alignment with the battery contact piece 391 provided on the upper surface side of the battery chamber 326. If the battery 246 is inserted into the battery chamber 326, it is locked by the battery lock lever 327, and is stored without falling out of the batter chamber 326 even if the battery lid 320 is not closed.

### <Effect of Configuration According to Present Exemplary Embodiment>

According to the above-described exemplary embodiments, a heat dissipation module can be provided that is attachable to and detachable from an image capturing apparatus, where this configuration enables both extension of use time of the image capturing apparatus by a plurality of batteries and improvement of heat dissipation performance using a cooling fan without increasing a size of a housing. Two battery chambers are provided that enable extending use time of the image capturing apparatus beyond that of the image capturing apparatus alone without shortening of available imaging time even under an imaging condition consuming a high amount of power. Since the cooling fan is located between the two battery chambers on a surface perpendicular to the attachment/detachment direction of the heat dissipation module, it is possible to suppress the housing from increasing in size in the attachment/detachment direction of the heat dissipation module.

As described above, according to the present disclosure, it is possible to suitably achieve both a configuration that supplies power to an image capturing apparatus and cools the image capturing apparatus.

### Other Exemplary Embodiment

While exemplary embodiments to which the present disclosure is applied have been described above, it is to be understood that the present disclosure is not limited to these exemplary embodiments and can be appropriately modified or changed within the scope of the appended claims.

The above-described exemplary embodiment(s) describe a cooling fan for blowing air to the camera main body 2 by the heat dissipation module 3. This is not seen to be limiting, and the cooling fan may be replaced with another element, such as a piezoelectric element.

The above-described exemplary embodiment(s) describe that an air passage of each of the camera main body 2 and the heat dissipation module 3 is formed with a duct. The present disclosure is not limited to this configuration as long as an air passage is formed.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-113076, filed Jul. 16, 2024, which is hereby incorporated by reference herein in its entirety.

What is claimed is:

1. An accessory attachable to an image capturing apparatus, the accessory comprising:
a fan;
an intake port configured to draw air into the fan;
a blow port configured to blow out air discharged from the fan;
a first battery chamber; and
a second battery chamber,
wherein the first battery chamber and the second battery chamber are located on a surface perpendicular to an attachment/detachment direction of the accessory,
wherein the fan is located between the first battery chamber and the second battery chamber, and
wherein the blow port is located on a surface including an attachment unit enabling the accessory to be attached to a lower surface of the image capturing apparatus.

2. The accessory according to claim 1, further comprising a duct to which the intake port and the blow port are connected, wherein the fan is located inside the duct.

3. The accessory according to claim 1, further comprising:
a first locking member configured to prevent a battery stored in the first battery chamber from falling out of the first batter chamber; and
a second locking member configured to prevent a battery stored in the second battery chamber from falling out of the second battery chamber,
wherein the first locking member and the second locking member are located inside the first battery chamber and the second battery chamber respectively.

4. The accessory according to claim 3, wherein the first locking member and the second locking member overlap with at least a part of a duct in the attachment/detachment direction of the accessory.

5. The accessory according to claim 1, further comprising:
a first contact piece configured to be connected to a battery stored in the first battery chamber; and
a second contact piece configured to be connected to a battery stored in the second battery chamber,
wherein at least one of the first contact piece or the second contact piece is located adjacent to a substrate.

6. The accessory according to claim 5, further comprising a connector configured to connect the image capturing apparatus to an external device via the accessory,
wherein the connector does not overlap the first contact piece and the second contact piece in the attachment/detachment direction of the accessory.

7. The accessory according to claim 6, further comprising a substrate that includes a control unit configured to control driving of the fan, wherein the substrate crosses over the fan.

8. The accessory according to claim 1, wherein a battery in at least one of the first battery chamber or the second battery chamber supplies power to at least one of the image capturing apparatus or the fan.

9. A cooling system comprising:
an image capturing apparatus; and
an accessory attachable to the image capturing apparatus,
wherein the accessory includes a fan, an intake port configured to draw air into the fan, a blow port configured to blow out air discharged from the fan, a first battery chamber, and a second battery chamber,
wherein the first battery chamber and the second battery chamber are located on a surface perpendicular to an attachment/detachment direction of the accessory,
wherein the fan is located between the first battery chamber and the second battery chamber,
wherein the blow port is located on a surface including an attachment unit enabling the accessory to be attached to a lower surface of the image capturing apparatus,
wherein the image capturing apparatus includes a ventilation port, an exhaust port, and a duct to which the ventilation port and the exhaust port are connected,
wherein the duct is thermally connected to a heat generation unit of the image capturing apparatus, and
wherein the blow port blows air into the ventilation port.
